(19) United States
(12) Patent Application Publication
(10) Pub. No.: US 2025/0326425 A1
(43) Pub. Date: Oct. 23, 2025

(54) STEER-BY-WIRE ROAD WHEEL ACTUATOR ANTI-ROTATION MECHANISM

(71) Applicant: Steering Solutions IP Holding Corporation, Saginaw, MI (US)

(72) Inventors: Sainan Feng, Saginaw, MI (US); Ryan D. Harris, Clio, MI (US)

(21) Appl. No.: 19/173,218

(22) Filed: Apr. 8, 2025

Related U.S. Application Data
(60) Provisional application No. 63/636,951, filed on Apr. 22, 2024.

(51) Int. Cl. B62D 5/00; B62D 5/04

(52) U.S. Cl. CPC B62D 5/005; B62D 5/0448

(57) ABSTRACT

A steer-by-wire system for a vehicle includes a rack moveable in an axial direction and defining a groove extending in the axial direction of the rack. The system also includes a housing surrounding at least a portion of the rack. The system further includes an anti-rotation device disposed proximate an outer surface of the rack at the mounting location of the rack and within the housing, the anti-rotation device comprising a bearing seated within the groove of the rack. The system yet further includes a delash bearing assembly in contact with the rack to radially bias the rack to a desired position.

### CROSS-REFERENCE TO RELATED APPLICATION

This application claims the benefits of priority to U.S. Provisional Patent Application Ser. No. 63/636,951, filed Apr. 22, 2024, the disclosure of which is incorporated by reference herein in its entirety.

### FIELD OF THE INVENTION

The disclosure of this application relates to steering systems and, more particularly, to a road wheel actuator anti-rotation mechanism for steering systems.

### BACKGROUND

Various electric power steering (EPS) systems have been developed for assisting an operator with vehicle steering. One type of EPS system is referred to as a rack electric power steering (REPS) system that utilizes an electric motor which drives a ball nut and rack. Some examples of steer-by-wire (SbW) road wheel actuators (RWAs) are simply ball screw based rack electric power steering systems without input shafts. In this configuration, a pinion shaft may still engage rack teeth to serve as an anti-rotation feature to avoid undesirable rotation/twisting of the rack during translation.

OEMs may be interested in removing the pinion for better packaging and cost during development of steer-by-wire systems. In a steer-by-wire system for a vehicle, an anti-rotation device is needed if a pinion is not used in the steering system to resist the rotation of the ball screw created by the loading of the ball nut thread.

### SUMMARY

According to one aspect of the disclosure, a steer-by-wire system for a vehicle includes a rack moveable in an axial direction and defining a groove extending in the axial direction of the rack. The system also includes a housing surrounding at least a portion of the rack. The system further includes an anti-rotation device disposed proximate an outer surface of the rack at the mounting location of the rack and within the housing, the anti-rotation device comprising a bearing seated within the groove of the rack. The system yet further includes a delash bearing assembly in contact with the rack to radially bias the rack to a desired position.

According to another aspect of the disclosure, an anti-rotation assembly includes a linear translating component moveable in an axial direction, the linear translating component defining an axial groove defined by a curved groove surface. The anti-rotation assembly also includes a bearing in contact with the linear translating component to prevent rotation of the linear translating component. The bearing assembly includes an inner race. The bearing assembly also includes an outer race having an outer surface disposed within the axial groove defined within the linear translating component to prevent rotation of the linear translating component, wherein outer race has curvature in both an axial direction of the groove and in a circumferential direction of the groove. The anti-rotation assembly also includes a delash bearing assembly. The delash bearing assembly includes a delash bearing having a curved inner surface which contacts an outer surface of the linear translating component to radially bias the linear translating component. The delash bearing assembly also includes a spring in contact with the delash bearing. The delash bearing assembly further includes an adjuster plug in contact with the delash bearing to adjust the force with which the delash bearing radially biases the linear translating component.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a steer-by-wire steering assembly; and

FIG. 2 is a perspective view of an anti-rotation mechanism for the rack electric power steering system disposed within a housing.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles which include various steering system schemes. As discussed herein, an electric power steering (EPS) system, including a steer-by-wire system, for example, includes an anti-rotation device where a pinion is not used in the steering system. The anti-rotation device resists rotation of a linear translating component. Such rotation is induced by the loading of an actuating component in contact with the linear translating component, such as the threading of a ball screw, for example.

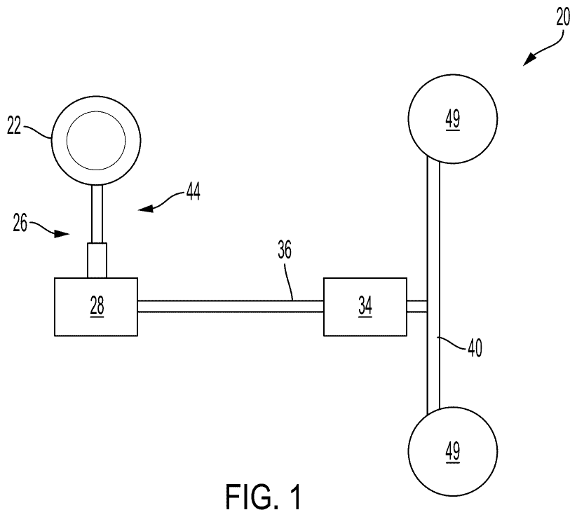

Referring initially to FIG. 1, a power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. A steering column 26 extends along an axis from the input device 22 to an output assembly 28. The embodiments disclosed herein are utilized in steering systems where the output assembly 28 is in operative communication (e.g., steer-by-wire, autonomous system, etc.) with an actuator 34 that is coupled to a linear translating component 40. The output assembly 28 has wired electrical communication 36 with the actuator 34. Actuator 34 drives the linear translating component 40 to provide steering control of the vehicle.

The linear translating component 40 is any component having a generally cylindrical cross-section along at least a portion of the length thereof and is driven in a substantially linear manner to effectuate adjustment of vehicle road wheels 49. In some embodiments, the linear translating component 40 is a ball screw. In other embodiments, the linear translating component 40 is a lead screw. The preceding examples are not limiting of the linear translating component 40.

In prior steer-by-wire steering systems, a pinion is utilized on an outer surface of the linear translating component 40 (e.g., “rack”) to provide steering input control of the linear translating component 40. Such a pinion also provides anti-rotation reaction forces on the linear translating component 40 to counter forces applied by the actuator 34, such as a ball nut, for example. However, the pinion and associated required components (e.g., pinion upper and lower bearing, rack bearing, adjuster plug, lower rotor, and rack teeth, etc.) may be undesirable in certain steering systems based on packaging requirements, cost, and manufacturing complexity, for example. The embodiments of an anti-rotation device disclosed herein provide the anti-rotation benefits of the previously required pinion, while eliminating the numerous components noted above. The above-referenced steering input control of the linear translating component 40 with a pinion is unnecessary in a steer-by-wire steering system, and such a system will benefit from the embodiments disclosed herein.

Although the embodiments disclosed herein are described in connection with an EPS system located at the lower/forward portion of a vehicle an EPS system located at other location of vehicle, such as rear steering, may benefit from the disclosed embodiments. Furthermore, the anti-rotation device disclosed herein may be used in any system that relies on a substantially cylindrical component driven in a translating manner and which requires or would benefit from limitation of rotation.

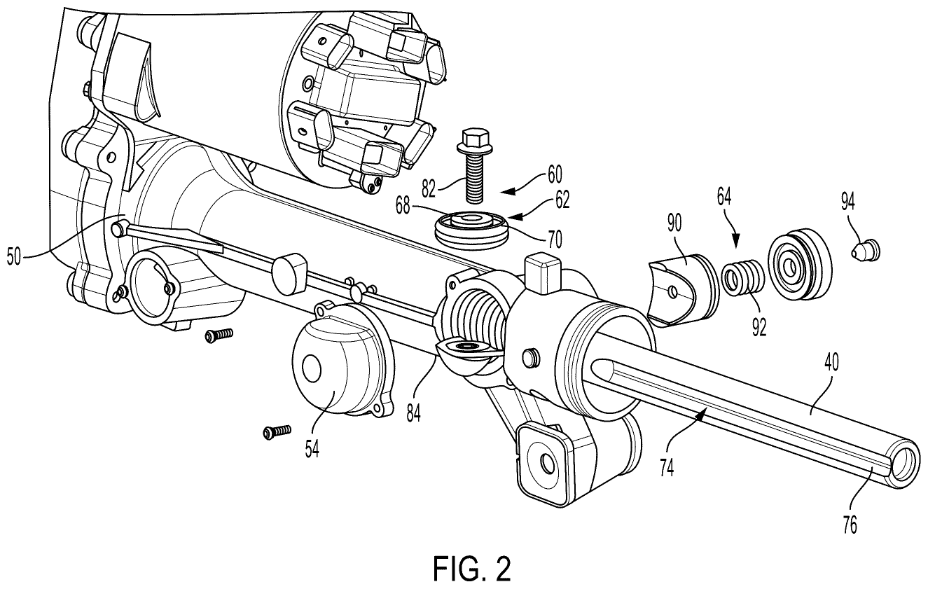

Referring to FIG. 2, a portion of a rack housing 50 is shown with a sealing boot removed to illustrate a portion of the linear translating component 40. The rack housing 50 houses at least a portion of the linear translating component 40. The rack housing 50 includes a cover 54 which may be repeatedly removed to access an interior region of the rack housing 50. The cover may be formed of plastic in some embodiments.

The linear translating component 40 extends longitudinally about an axis A in what is referred to as an axial direction herein. An end of the linear translating component 40 is operatively coupled to one or more components which connect the linear translating component 40 to road wheels of the vehicle. For example, tie rods and other components may be used in a conventional manner. This connection allows axial movement of the linear translating component 40 to adjust the road wheels in a manner required to carry out steering maneuvers.

An anti-rotation assembly 60 is included to prevent rotation of the linear translating component during operation. The anti-rotation assembly 60 is provided to counter forces applied by the actuating component 34, such as a ball nut, for example. The anti-rotation assembly 60 includes an anti-rotation bearing 62 and a delash bearing assembly 64. The anti-rotation assembly 60 is at least partially disposed within the rack housing 50, such as within a compartment covered by the cover 54. The bearing 62 may be a standard bearing that is machined or otherwise modified to provide the features disclosed herein. Alternatively, the bearing 62 may be a specifically manufactured bearing. Regardless of the process in which the bearing 62 is made, the bearing 62 includes an inner race 68, an outer race 70 and a plurality of balls disposed between the inner race 68 and the outer race 70.

The outer race 70 is seated within a groove 74 defined in the linear translating component 40. The groove 74 extends longitudinally in the same direction as the longitudinal axis A of the linear translating component 40 to accommodate axial movement of the linear translating component 40 relative to the outer race 70 of the bearing 62, while allowing the outer race 70 to remain within the groove 74.

The groove 74 is defined by a curved groove surface 76. The outer race 70 of the bearing 62 is shaped to maximize contact with a radius of the curved groove surface 76. In other words, when installed within the groove 74, the outer race 70 has a curvature in both the axial direction of the groove 74 and in a circumferential direction of the groove 74. While the radius of curvature of each of the curved groove surface 76 and the outer race 70 is not identical in some embodiments, the curvature of each component is matched similarly to allow the bearing 62 to prevent rotation of the linear translating component 40. In operation, as the linear translating component 40 (e.g., ball screw) is biased to rotate due to torque from the actuating component (e.g., ball nut), disposal of the curved outer race 70 within the groove 74 reacts on the curved groove surface 76 to prevent rotation of the linear translating component 40. The inner race 68 is in contact with a component, such as flange bolt 82 which is threaded or otherwise secured to a flange 84 extending from the rack housing 50. The contact between the inner race 68 and the flange bolt 82 secures the bearing 62 to surrounding structures.

The delash bearing assembly 64 includes a rack bearing 90, with a curved inner surface which contacts the outer surface of the linear translating component 40 to radially bias the linear translating component 40 to a desired position in a delashing manner. The force applied by the rack bearing 90 is adjustable by any suitable assembly, including a spring 92 and adjuster plug 94. In the illustrated embodiment, the delash bearing assembly 64 and the anti-rotation assembly 60 are located at axial locations of the linear translating component 40 which overlap with each other. Furthermore, in some embodiments, the delash bearing assembly 64 and the anti-rotation assembly 60 are located on opposite sides of the linear translating component 40 (e.g., 180 degreed spaced from each other).

The embodiments disclosed herein allow for a reduction in packaging space required of EPS systems based on removal of several components, including a pinion, a pinion upper and lower bearing, a lower rotor, and rack teeth in the case of a REPS system. Additionally, cost and complexity associated with manufacturing and assembly of the overall system is reduced with the anti-rotation assembly 60 disclosed herein, particularly when used in conjunction with the delash bearing assembly 64. This is also coupled with a mating wear component to meet NVH and friction requirements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A steer-by-wire system for a vehicle comprising:
a rack moveable in an axial direction and defining a groove extending in the axial direction of the rack;
a housing surrounding at least a portion of the rack;
an anti-rotation device disposed proximate an outer surface of the rack at the mounting location of the rack and within the housing, the anti-rotation device comprising a bearing seated within the groove of the rack; and
a delash bearing assembly in contact with the rack to radially bias the rack to a desired position.

2. The steer-by-wire system of claim 1, wherein the delash bearing assembly comprises:
a rack bearing having a curved inner surface which contacts an outer surface of the rack to radially bias the rack;
a spring in contact with the rack bearing; and
an adjuster plug in contact with the rack bearing to adjust the force with which the rack bearing radially biases the rack.

3. The steer-by-wire system of claim 2, wherein the rack is a ball screw, the steer-by-wire system further comprising a ball nut threadedly coupled to the ball screw, wherein rotation of the ball nut actuates translation of the ball screw.

4. The steer-by-wire system of claim 2, wherein an outer surface of the bearing is disposed within the groove to prevent rotation of the rack.

5. The steer-by-wire system of claim 2, wherein the groove of the rack is defined by a curved groove surface.

6. The steer-by-wire system of claim 5, wherein the outer surface of the bearing has curvature in both an axial direction of the groove and in a circumferential direction of the groove.

7. The steer-by-wire system of claim 6, wherein the curvature of the outer surface of the bearing in the circumferential direction of the groove corresponds to the curvature of the curved groove surface.

8. The steer-by-wire system of claim 2, wherein the bearing extends through an opening of the rack housing.

9. The steer-by-wire system of claim 2, wherein the bearing of the anti-rotation device and the rack bearing of the delash bearing assembly contact the rack at an overlapping axial location of the rack.

10. The steer-by-wire system of claim 2, wherein the bearing of the anti-rotation device and the rack bearing of the delash bearing assembly are located on opposite sides of the rack.

11. An anti-rotation assembly comprising:
a linear translating component moveable in an axial direction, the linear translating component defining an axial groove defined by a curved groove surface;
a bearing in contact with the linear translating component to prevent rotation of the linear translating component, the bearing assembly comprising:
an inner race; and
an outer race having an outer surface disposed within the axial groove defined within the linear translating component to prevent rotation of the linear translating component, wherein outer race has curvature in both an axial direction of the groove and in a circumferential direction of the groove; and
a delash bearing assembly comprising:
a delash bearing having a curved inner surface which contacts an outer surface of the linear translating component to radially bias the linear translating component;
a spring in contact with the delash bearing; and
an adjuster plug in contact with the delash bearing to adjust the force with which the delash bearing radially biases the linear translating component.

12. The anti-rotation assembly of claim 11, wherein the groove of the linear translating component is defined by a curved groove surface.

13. The anti-rotation assembly of claim 12, wherein the outer surface of the bearing has curvature in both an axial direction of the groove and in a circumferential direction of the groove.

14. The anti-rotation assembly of claim 13, wherein the curvature of the outer surface of the bearing in the circumferential direction of the groove corresponds to the curvature of the curved groove surface.

15. The anti-rotation assembly of claim 11, further comprising a housing for containing at least a portion of the linear translating component, wherein the bearing extends through an opening of the housing.

16. The anti-rotation assembly of claim 15, wherein the opening is covered with a cover formed of at least one of plastic and metal.

17. The anti-rotation assembly of claim 11, wherein the bearing of the anti-rotation device and the rack bearing of the delash bearing assembly contact the rack at an overlapping axial location of the rack.

18. The anti-rotation assembly of claim 11, wherein the bearing of the anti-rotation device and the rack bearing of the delash bearing assembly are located on opposite sides of the rack.
